(19) United States
(12) Patent Application Publication
(10) Pub. No.: US 2005/0147579 A1
(43) Pub. Date: Jul. 7, 2005

(54) Antifouling composition comprising an enzyme in the absence of its substrate

(75) Inventors: Ib Schneider, Copenhagen (DK); Knud Allermann, Rungsted Kyst (DK)

Correspondence Address: BROWDY AND NEIMARK, P.L.L.C.;624 NINTH STREET, NW, SUITE 300, WASHINGTON, DC, 20001-5303, US

(73) Assignee: BIOLOCUS APS, HORSHOLM (DK)

(21) Appl. No.: 10/510,823

(22) PCT Filed: Apr. 11, 2003
(86) PCT No.: PCT/DK03/00249

(30) Foreign Application Priority Data
Apr. 12, 2002 (DK) PA 2002 00545

(51) Int. Cl. A01N 65/00

(52) U.S. Cl. 424/78.09; 424/94.4

(57) ABSTRACT

The present invention in one aspect relates to a coating composition comprising at least one enzyme capable of acting on a compound, wherein said action results in the formation of an antifouling species comprising an antifouling activity, and wherein said compound does not form part of said coating composition. The coating composition preferably comprises at least one oxidase capable of acting on a compound, such as a substrate for said oxidase, wherein said action results in the formation of an antifouling species including an antimicrobial species comprising an antimicrobial activity. More preferred, the oxidase comprises an activity which results in the formation of a peroxide. The oxidase can be present in said coating composition in combination with one or more additional enzymes including, but not limited to, an esterase, including a lipase, an amidase, including a protease, and a polysaccharide degrading enzyme, wherein said one or more additional enzyme(s), alone or in any combination, can be included in the presence or absence of one or more substrates for one or more of said enzymes.

All patent and non-patent references cited in this application are hereby incorporated by reference in their entirety.

### FIELD OF THE INVENTION

The present invention relates to a coating composition comprising at least one enzyme and no substrate for said at least one enzyme. When the coating composition is applied to an object and comes into contact with an external environment wherein said substrate is present, the at least one enzyme catalyses said substrate and generates an antifouling species, including an antimicrobial species having an antimicrobial activity. The enzyme is preferably an oxidase the activity of which results in the formation of a peroxide compound.

### BACKGROUND OF THE INVENTION

Antifouling species such as e.g. antimicrobial species, antibacterial species, antifungal species, biocides, and biorepellents, are in broad use today. The importance of protecting various objects with such compounds against the attack of fouling organisms, bacteria, and fungi continues to increase.

For example, structures in contact with seawater, for example ships, oceanic constructions, fish farming nets, buoys and industrial water systems, are constantly exposed to water inhabited by various organisms. Therefore, as time passes by, microorganisms such as bacteria and diatoms and, further, fouling organisms of larger size, for example barnacles, mussels and sea lettuce, adhere to and grow on said structures.

Marine organisms covering a surface of a structure exposed to seawater result in e.g. corrosion of the covered part; decreased marine fuel efficiency due to increased frictional resistance of the ship bottom against seawater; deaths of fish and shellfish, or decreased working efficiency, due to clogging of fish farming nets; and sinking buoys due to reduced buoyancy. It is thus important to apply an antifouling treatment to such structures exposed to seawater.

Meanwhile, as can be easily understood from the serious problem posed by an increasing incidence of e.g. nosocomial infection due to meticillin-resistant staphylococci, it is also very important to treat interior walls, fixtures, furnishings, upholstery, etc. against the growth of bacteria and fungi in order to protect the internal environment of places such as hospitals, schools, and hotels against such microorganisms.

The antimicrobial technology for the structures exposed to seawater or the interior walls of a hospital, for instance, includes a method which comprises incorporating a compound having antimicrobial activity in the very object to be protected and a method which comprises coating the surface of an object with a coating composition containing a compound having antimicrobial activity.

For example, the conventional antifouling technology for structures exposed to seawater comprises coating the surface of structures with an antifouling paint containing a compound having antimicrobial activity. This antifouling paint is designed to release such a compound gradually from the film into water by utilizing its solubility to thereby provide a sustained antifouling effect.

As the technology for keeping the interior environment of hospitals, etc., against bacteria and fungi, it is common practice to apply a coating containing a compound having antibacterial/antifungul activity to the surface of the interior walls, fixtures, furnishings, upholstery, etc.

When an object is treated with a compound having antifouling or antibacterial/antifungal activity, it is of course expected that the effect of the treatment will be expressed steadily over as long a time as possible. However, according to the above technology comprising coating an object surface with a coating composition containing an antimicrobial compound itself, satisfactory effect is obtained only for a limited time period following the treatment. Even when the content of those active compound is high, the effect declines rapidly with time, thus failing to ensure a sustained long-term effect.

As compounds having antifouling activity for incorporation in antifouling paints, organotin compounds have been mostly employed. A variety of other compounds such as aliphatic carboxylic acids, aromatic carboxylicacids, aliphatic alcohols, phenolic compounds and e.g. hydrogen peroxide are also known to have antimicrobial activity.

However, as pointed out frequently, organotin compounds have high toxicity and, when formulated in antifouling paints, find their way into the seawater to contaminate the marine environment. In addition, the protection of workers against hazards adds to the difficulty of use of those compounds.

Aliphatic carboxylic acids, aromatic carboxylic acids, aliphatic alcohols, and phenolic compounds are free from safety and pollution problems just as is hydrogen peroxide. However, when those compounds are directly formulated into an antifouling paint and applied to the structures in water, they are eluted from the films into the surrounding water in a very brief period of time because of their highly solubility. It is thus impossible to maintain an elution level necessary for displaying antifouling property for a long period of time. When these compounds are formulated into an antibacterial/antifungal paint and applied to the interior walls of hospitals, they are readily evaporated off or driven off by the water contained in the atmosphere as it is the case with said antifouling paint. Thus it also fails to provide a long-term antibacterial/antifungal effect. Besides, carboxylic acids in general emanate intense foreign odors so that they are difficult to use just as are toxic compounds.

Although hydrogen peroxide is highly safe and free from the above problems, this species is a relatively unstable compound and it has so far been regarded as practically impossible to use it directly as an ingredient in antifouling or antibacterial/antifungal paints.

The demand exists for a new technology for sustained long-term effect without using excessive an unnecessary amounts of hazardous chemicals posing a risk to human health. It is one objective of the present invention to provide novel coating compositions and methods for sustained enzymatic production of antimicrobial species, wherein said enzyme from such compositions of species having antimicrobial activity.

U.S. Pat. No. 6,004,510 (Lever Brothers) discloses a process for the treatment of a surface with a hygiene agent which can include the steps of: a) providing at the surface a non-photochemical catalyst (such as a transition metal compound) which catalyses the formation of the hygiene agent from one or more precursors, whereby the catalyst becomes deposited at the surface, and, b) subsequently treating the surface with a treatment agent (such as a solution of hydrogen peroxide) having the or each hygiene agent precursor, such that the hygiene agent is generated at the surface. The disclosure also provides a process which includes the step of treating the surface which has a non-photochemical catalyst bound thereto with a treatment agent having at least one hygiene agent precursor which forms said hygiene agent in the presence of the catalyst, and a process for the manufacture of an article which includes the step of incorporating therein, at the time of manufacture, a non-photochemical catalyst capable of transforming at least one hygiene agent precursor into a hygiene agent. All of the examples relate to inorganic metal compounds.

U.S. Pat. No. 5,998,200 (Duke University) discloses a method for preventing fouling of an aquatic apparatus by an aquatic organism which comprises affixing a biologically active chemical to a surface intended for use in contact with an aquatic environment containing the organism, wherein the chemical is an enzyme, repellant, chelating agent, enzyme inhibitor, or non-metallic toxicant capable of hindering the attachment of the organism to the surface while affixed to the surface, is disclosed along with improved apparatuses which are produced using the method. The present invention in one preferred aspect relates to an enzyme in the form of an oxidase the activity of which results in the formation of a peroxide.

FR 2562554 A1 (Noel) discloses a anti-fouling coating composition comprising a protease and/or an endopeptidase. The present invention in one preferred aspect relates to an enzyme in the form of an oxidase the activity of which results in the formation of a peroxide.

U.S. Pat. No. 6,150,146 (Nippon Paint) discloses a method for controlled release of compounds having antimicrobial activity and a coating composition capable of controlled release of compounds having antimicrobial activity is provided. The disclosure relates to a method for releasing a compound having antimicrobial activity from a matrix at a controlled rate, which comprises incorporating an enzyme and a substrate in said matrix beforehand to allow said enzyme and said substrate to react with each other in said matrix to thereby produce said compound having antimicrobial activity; and further relates to a coating composition comprising a film-forming resin, an enzyme, and a substrate, said enzyme being capable of reacting with said substrate to produce a compound having antimicrobial activity. The present invention in one aspect relates to a composition, wherein an enzyme is present in the absence of its substrate.

WO 00/68324 (Novo Nordisk) relates to a preserved and/or conserved water based paint composition comprising an oxidoreductase, an oxidizing agent, a binder and at least 10% w/w water. The present invention in one aspect relates to a composition, wherein an enzyme is present in the absence of its substrate, including an oxidizing agent in the form of oxygen.

WO 00/75293 (Danisco) relates to an anti-fouling composition comprising (i) a surface coating material; (ii) an enzyme obtained or obtainable from a marine organism; and (iii) (a) a substrate for the enzyme; and/or (b) a precursor enzyme and a precursor substrate, wherein the precursor enzyme and the precursor substrate are selected such that a substrate for the enzyme is generatable by action of the precursor enzyme on the precursor substrate; wherein the enzyme and the substrate are selected such that an anti-foulant compound is generatable by action of the enzyme on the substrate. The present invention in one aspect relates to a composition, wherein an enzyme is present in the absence of its substrate.

WO 0027204 (Novo Nordisk) discloses a phenol oxidising enzyme system, including a peroxidase an a peroxide source. The present invention in one aspect relates to a composition, wherein an enzyme is present in the absence of its substrate.

U.S. Pat. No. 6,221,821 (Novo Nordisk/Novozymes) in one embodiment relates to a paint comprising for conservation purposes a variant of a haloperoxidase. Haloperoxidases consume peroxides when oxidising halides. The present invention in one aspect relates to a composition, wherein an enzyme is present in the absence of its substrate.

U.S. Pat. No. 6,251,386 (Novo Nordisk) relates to an antimicrobial composition comprising a haloperoxidase and hydrogen peroxide. The present invention in one aspect relates to a composition, wherein an enzyme is present in the absence of its substrate.

U.S. Pat. No. 5,919,689 (Selvig) discloses marine antifouling compositions and/or paints containing, microorganism(s), or mixtures of hydrolytic enzyme(s) and microorganism(s), wherein the microorganism or hydrolytic enzyme reduce fouling of a surface coated by the marine antifouling composition and/or paint. Such compositions and/or paints may contain a catalytically effective amount of an inorganic salt. Also disclosed are articles coated with the composition and/or paint. Finally, methods are disclosed for reducing fouling of a marine surface, for reducing marine corrosion, for limiting absorption of water by a marine surface, for reducing the coefficient of drag of a marine surface, removing marine growth from a marine surface, and for reducing mildew fungus on a marine surface. The present invention does not employ a coating composition comprising a microorganism.

### SUMMARY OF INVENTION

The present invention in one aspect relates to a composition comprising at least one enzyme capable of acting on a compound, wherein said action results in the formation of an antifouling species comprising an antifouling activity, and wherein said compound does not form part of said composition.

The composition is preferably a coating composition further comprising a pigment, or a hygienic composition further comprising a fragrance, or a composition as stated herein above further comprising both a pigment and a fragrence.

In another aspect there is provided a method for preparing such compositions, including a coating composition, as well as uses of such a coating composition, including uses as describe in more detail herein below.

In one aspect of the invention there is provided a method for reducing marine corrosion comprising the step of coating a marine surface with a marine antifouling composition, whereby the composition forms at least one film that reduces adsorption of corrosive molecules to the surface. Also disclosed is a method wherein the composition impedes surface corrosion and intergranular corrosion.

Another aspect of the invention is a method for reducing marine corrosion comprising the step of coating a marine surface with a marine antifouling paint, whereby the paint forms at least one film that reduces adsorption of corrosive molecules to the surface. In yet another aspect of the claimed invention, a method is disclosed, wherein the paint impedes surface corrosion and intergranular corrosion.

Yet another aspect of the invention is a method for limiting absorption of water by a marine surface comprising the step of coating the surface with a marine antifouling composition or marine antifouling paint, whereby the composition or paint produces a film which in turn reduces the porosity of the surface.

In another aspect of the invention, a method is disclosed for reducing the coefficient of drag of a marine surface comprising the step of coating the surface with a marine antifouling composition or marine antifouling paint. The invention is also directed to methods of using the marine antifouling composition or marine antifouling paint wherein surfactants capable of acting as wetting agents are produced by microorganisms in contact with the composition or paint.

An aspect of the invention is a method for removing marine growth from a marine surface, comprising the step of coating the surface with a marine antifouling composition or marine antifouling paint. Another aspect of the invention is a method of using the marine antifouling composition or marine antifouling paint wherein the marine growth is hard or soft growth. Yet another aspect of the invention is a method of using the marine antifouling composition or marine antifouling paint, wherein e.g. hydrolytic enzymes attack exudates of existing growths and causes release of hard and soft growth.

In another aspect of the invention, marine antifouling compositions or marine antifouling paints are disclosed that comprise an inorganic salt present in a catalytically effective amount. Yet another aspect of the invention is a method of reducing the tendency of a propeller to cavitate under a load, comprising the step of coating a surface of the propeller with a marine antifouling composition or marine antifouling paint. Still another aspect of the invention is a method of using a marine antifouling composition for reducing mildew fungus on a marine surface, comprising the step of coating a marine surface with a marine antifouling composition, whereby the composition forms at least one film that reduces the adsorption or attachment of mildew fungus to the surface, or impedes the growth of mildew fungus on the marine surface.

Definitions

Anti-fouling: The effect of controlling, reducing and/or eliminating over time the number of undesirable microorganisms in a bio-film.

Antifouling species: Species such as antimicrobial species, antibacterial species, antifungal species, biocides, biorepellents, and the like.

Bio-film: Habitation of microbial organisms on a solid or semi-solid surface.

Coating composition: Composition for coating an object, such as a paint.

Co-factor: Additional factor required by an enzyme.

Compound: Substrate for an enzyme capable of catalysing said compound, wherein said catalysis results in the formation of an antimicrobial species comprising an antimicrobial activity.

Enzyme: Biomolecule comprising a plurality of amino acids and capable of catalysing conversion of substrates into products. The terms enzyme and precursor enzyme are used interchangably unless otherwise indicated. An enzyme is acting on a compound as defined herein when said action generates an antifouling species having antifouling activity. A precursor enzyme is any enzyme capable of providing to the enzyme, by means of degradation or otherwise, a substrate for said enzyme in the form of said compound.

Marine organism: Any organism capable of habitating in an aqueous environment, including organisms capable of forming undesirable bio-films.

Microbial organism: Any organism belonging to the classes of prokaryotes and lower eukaryotes, including bacteria, yeasts, fungal cells and slime molds.

Oxidase: Enzyme the activity of which results in an oxidation, including an oxidation resulting in the formation of a peroxide, including hydrogenperoxide.

Peroxide: Product resulting from a reaction involving an oxidase.

Precursor compound: Precursor compounds are capable of being catalysed by a precursor enzyme, wherein said catalysis results in the formation of a compound capable of being catalysed by an enzyme under the generation of an antifouling species, including an antimicrobial species having an antimicrobial activity.

Secretion: Process of translocating a compound or precursor compound across the outer membrane of a microbial species. Secretion applies to compounds which remain membrane associated and to compounds which are subsequently released into an external environment.

Surface: Outer part of e.g. a microbial organism in contact with the external environment.

### DETAILED DESCRIPTION OF THE INVENTION

The present invention in one preferred embodiment relates to a coating composition comprising at least one enzyme, preferably an oxidase, capable of acting on a compound, such as a substrate for said oxidase, wherein said action results in the formation of an antifouling species including an antimicrobial species comprising an antimicrobial activity, and wherein said compound does not form part of said coating composition.

In a more preferred embodiment the enzyme is an oxidase the activity of which results in the formation of a peroxide.

The oxidase can be present in said coating composition in combination with one or more additional enzymes including, but not limited to, an esterase, including a lipase, an amidase, including a protease, and a polysaccharide degrading enzyme, wherein said one or more additional enzyme(s), alone or in any combination, can be included in the presence or absence of one or more substrates for one or more of said enzymes.

The antifouling species comprising an antifouling activity is preferably generated when the at least one enzyme acts on a compound, or a precursor thereof including a polymer, capable of being secreted by a microbial organism. The compound can be a degradation product of a precursor compound, including a polymer secreted by and/or located on the surface of microbial organisms, wherein said degradation product is provided by a precursor enzyme acting on said precursor compound.

Antifouling Species and Enzymes Resulting in Their Production

The species of the invention having antifoulant or antimicrobial activity can be any species capable of being produced as the result of an enzyme-substrate reaction. As such, there can be mentioned many species having antifouling activity, species having antibacterial/antifungal activity, species having biocidal activity, and species having biorepellent activity.

The species having antimicrobial activity is thus produced by an enzymatic reaction between an enzyme and a substrate in the form of a compound which is preferably secreted by a microbial organism. Species having antimicrobial activity can be any species obtained as the direct result of enzymatic reaction between the enzyme and the compound, as well as any species formed from the product of such enzymatic reaction through further enzymatic and/or chemical reaction.

The compounds are not limited to microbial secretion products. The compounds of the invention can be any non-toxic compound supplied to a predetermined environment, such as a dock harbouring a ship hull, and capable of being converted into an antifouling species, including an antimicrobial species by the action of the at least one enzyme, including an oxidase.

Furthermore, it is also envisaged that antifouling species, including an antimicrobial species can be generated by a combination of i) enzymatic action on secreted microbial products, including polymers and degradation products thereof, and ii) enzymatic action on exogenously added compounds or precursor compounds, wherein said combination of enzymatic actions results in the formation of one or more antifouling species, including an antimicrobial species having an antimicrobial activity.

In accordance with the invention, the at least one enzyme, preferably an oxidase the activity of which results in the production of peroxide, including hydrogenperoxide, is comprised in the coating composition according to the invention in an effective amount to reduce or prevent fouling of a surface coated with the composition. In the present context the term “an effective amount” means an amount which is sufficient to control or eliminate or reduce or at least substantially reduce the settling of microbial organisms, plants and/or animals, including aquatic organisms such as bacteria, protozoa, algae and invertebrates, on a surface coated with the composition according to invention.

In order to test the amount of the at least one enzyme required in order to sufficiently reduce or prevent fouling, any type of standard or modified antifouling bioassay can be applied, including settlement assays as described by Willemsen (1994). In one presently preferred embodiment, the amount of the enzyme is in the range of from about 0.1 to preferably less than 10% (w/w) coating composition (dry weight), such as from about 0.1 to less than 9% (w/w), for example from about 0.1 to less than 8% (w/w), such as from about 0.1 to less than 7% (w/w), for example from about 0.1 to less than 6% (w/w), such as from about 0.1 to less than 5.5% (w/w), for example from about 0.1 to less than 5.0% (w/w), such as from about 0.1 to less than 4.5% (w/w), for example from about 0.1 to less than 4.0% (w/w), such as from about 0.1 to less than 3.5% (w/w), for example from about 0.1 to less than 3.0% (w/w), such as from about 0.1 to less than 2.5% (w/w), for example from about 0.1 to less than about 2.0% (w/w), such as from about 0.1 to less than about 1.5% (w/w), for example from about 0.1 to less than about 1.0% (wlw), such as from about 0.1 to less than about.0.5% (w/w).

In another embodiment the amount of the enzyme is present in the coating composition in the range of from about 0.2% (w/w) to about 0.4% (w/w) coating composition (dry weight), such as from about 0.4% (w/w) to about 0.6% (w/w), for example from about 0.6% (w/w) to about 0.8% (w/w) coating composition, such as from about 0.8% (w/w) to about 1.0% (w/w), for example from about 1.0% (w/w) to about 1.2% (w/w) coating composition, such as from about 1.2% (w/w) to about 1.4% (w/w), for example from about 1.4% (w/w) to about 1.6% (w/w) coating composition, such as from about 1.6% (w/w) to about 1.8% (w/w), for example from about 1.8% (w/w) to about 2.0% (w/w) coating composition, such as from about 2.0% (w/w) to about 2.5% (w/w), for example from about 2.5% (w/w) to about 3.0% (w/w) coating composition, such as from about 3.0% (w/w) to about 3.5% (w/w), for example from about 3.5% (w/w) to about 4.0% (w/w) coating composition, such as from about 4.0% (w/w) to about 4.5% (w/w), for example from about 4.5% (w/w) to about 5.0% (w/w) coating composition.

In a preferred embodiment the at least one enzyme is an oxidase the activity of which results in the formation of a peroxide, including hydrogen peroxide. The amount of hydrogen peroxide generated in accordance with the present invention depends on the amount of available compound on which the at least one oxidase can act. It will be possible to determine the amount of hydrogen peroxide generated by using the method of Janssen and Ruelius disclosed in Biochem. Biophys. Acta (1968), vol. 151, pages 330-342.

The amount of hydrogen peroxide generated is in preferred embodiments about or at least about 1 nmol/cm²/day, such as 2 nmol/cm²/day, for example 3 nmol/cm²/day, such as 4 nmol/cm²/day, for example 5 nmol/cm²/day, such as 2 nmol/cm²/day, for example 3 nmol/cm²/day, such as 4 nmol/cm²/day, for example 5 nmol/cm²/day, such as 6 nmol/cm²/day, for example 7 nmol/cm²/day, such as 8 nmol/cm²/day, for example 9 nmol/cm²/day, such as 10 nmol/cm²/day, for example 12 nmol/cm²/day, such as 14 nmol/cm²/day, for example 16 nmol/cm²/day, such as 18 nmol/cm²/day, for example 20 nmol/cm²/day, such as 22 nmol/cm²/day, for example 24 nmol/cm²/day, such as 26 nmol/cm²/day, for example 28 nmol/cm²/day, such as 30 nmol/cm²/day, for example 32 nmol/cm²/day, such as 34 nmol/cm²/day, for example 36 nmol/cm²/day, such as 38 nmol/cm²/day, for example 40 nmol/cm²/day, such as 42 nmol/cm²/day, for example 44 nmol/cm²/day, such as 46 nmol/cm²/day, for example 48 nmol/cm²/day, such as 50 nmol/cm²/day, for example 55 nmol/cm²/day; such as 60 nmol/cm²/day, for example 65 nmol/cm²/day, such as 70 nmol/cm²/day, for example 75 nmol/cm²/day, such as 80 nmol/cm²/day, for example 85 nmol/cm²/day, such as 90 nmol/cm²/day, for example 95 nmol/cm²/day, such as 100 nmol/cm²/day, for example 110 nmol/cm²/day, such as 120 nmol/cm²/day, for example 130 nmol/cm²/day, such as 140 nmol/cm²/day, for example 150 nmol/cm²/day, such as 160 nmol/cm²/day, for example 170 nmol/cm²/day, such as 180 nmol/cm²/day, for example 190 nmol/cm²/day, such as 200 nmol/cm²/day, for example 220 nmol/cm²/day, such as 240 nmol/cm²/day, for example 260 nmol/cm²/day, such as 280 nmol/cm²/day, for example 300 nmol/cm²/day, such as 320 nmol/cm²/day, for example 340 nmol/cm²/day, such as 360 nmol/cm²/day, for example 380 nmol/cm²/day, such as 400 nmol/cm²/day, for example 420 nmol/cm²/day, such as 440 nmol/cm²/day, for example 460 nmol/cm²/day, such as 480 nmol/cm²/day, for example 500 nmol/cm²/day, such as 520 nmol/cm²/day, for example 540 nmol/cm²/day, such as 560 nmol/cm²/day, for example 580 nmol/cm²/day, such as 600 nmol/cm²/day, for example 620 nmol/cm²/day, such as 640 nmol/cm²/day, for example 660 nmol/cm²/day, such as 680 nmol/cm²/day, for example 700 nmol/cm²/day, such as 720 nmol/cm²/day, for example 740 nmol/cm²/day, such as 760 nmol/cm²/day, for example 780 nmol/cm²/day, such as 800 nmol/cm²/day, for example 820 nmol/cm²/day, such as 840 nmol/cm²/day, for example 860 nmol/cm²/day, such as 880 nmol/cm²/day, for example 900 nmol/cm²/day, such as 920 nmol/cm²/day, for example 940 nmol/cm²/day, such as 960 nmol/cm²/day, for example 980 nmol/cm²/day, such as 1000 nmol/cm²/day.

Preferred oxidases include, but is not limited to, malate oxidase; glucose oxidase; hexose oxidase; cholesterol oxidase; arylalcohol oxidase: galactose oxidase; alcohol oxidase; lathosterol oxidase; aspartate oxidase; L-amino-acid oxidase; D-amino-acid oxidase; amine oxidase; D-glutamate oxidase; ethanolamine oxidase; NADH oxidase; urate oxidase (uricase); superoxide dismutase; and the like.

In one preferred embodiment the at least one enzyme is a hexose oxidase, including, but not limited to any oxidoreductase of class EC 1.1.3.5. Hexose oxidases are enzymes which in the presence of oxygen is capable of oxidising D-glucose and several other reducing sugars including maltose, lactose and cellobiose to their corresponding lactones with subsequent hydrolysis to the respective aldobionic acids. Hexose oxidase differs from another oxidoreductase, glucose oxidase, which can only convert D-glucose, in that the enzyme can utilise a broader range of sugar substrates.

Hexose oxidase is produced naturally by several marine algal species. Such species are found inter alia in the family Gigartinaceae. In one preferred embodiment the hexose oxidase is obtained from the marine algae Chondrus cripus. Reference is made to EP 0 832 245. WO 96/40935 and WO 98/13478 also disclose the cloning and expression in recombinant host organisms of a gene encoding a protein with HOX activity.

In another preferred embodiment the compound and the enzyme, respectively, is selected from glucose/hexose oxidase; glucose/glucose oxidase; L amino acid/L amino acid oxidase; galactose/galactose oxidase; lactose/beta-galactosidase/hexose oxidase; 2-deoxyglucose/glucose oxidase; pyranose/pyranose oxidase; and mixtures thereof.

The antifouling species, including an antimicrobial species can be generated directly by the action of the at least one enzyme, optionally in combination with an initial action of one or more precursor enzymes. In the latter case, the precursor enzyme(s) and the precursor compound(s) are selected such that the precursor enzyme(s) eventually generates the compound.

An example of a precursor enzyme is any polysaccharide digesting enzyme, including amyloglucosidase, and an example of a precursor compound is any polysaccharide.

Thus in one embodiment the coating composition can comprise at least one oxidase such as e.g. hexose oxidase and at least one amylolytically active enzyme, such as e.g. an amyloglucosidase, and/or at least one hemicellulolytically active enzyme, such as e.g. a xylanase, and/or at least one cellulolytically active enzyme, such as e.g. a cellulase, including any combination of an oxidase with the aforementioned polysaccharide degrading enzymes, such as an oxidase and an amylolytically active enzyme, an oxidase and a hemicellulolytically active enzyme, an oxidase and a cellulolytically active enzyme, an oxidase and an amylolytically active enzyme and a hemicellulolytically active enzyme, such as an oxidase and an amylolytically active enzyme and a cellulolytically active enzyme, and an oxidase and a hemicellulolytically active enzyme and an cellulolytically active enzyme.

A number of other enzymes, in addition to oxidases, can also be employed in accordance with the present invention, either alone or in any combination, including a combination wherein the at least one oxidase is also present.

Esterases and lipases are triacylglycerol hydrolysing enzymes capable of splitting of fatty acids having short, medium and long chain lengths. Esterases and lipases degrade cell wall lipids and other lipid associated macromolecules at the surface of microbial organisms.

Accordingly, in one embodiment the at least one enzyme is an esterase and the compound is an ester bond-containing species. Examples of esterases include, but is not limited to, carboxylesterase, arylesterase, acetylesterase, and the like.

In yet another embodiment the at least one enzyme/precursor enzyme is a lipase such as, but not limited to, triacylglycerol lipase, lipoprotein lipase, and the like.

Proteinaceous materials involved in fouling the surfaces are subject to disruption by proteases. Families of proteolytic enzymes are well known, as reviewed in Neurath, Science 224, 350-357, 1984. Candidates for use in non-toxic anti-fouling coating compositions can be drawn from these families, trypsin and subtilisn being an example of serine proteases of type I and II, papain being an example of a sulfhydryl protease, pepsin being an example of an acid protease, carboxypeptidase A and B and thermolysin being examples of metalloproteases of type I and II. Other protease families of relevance are the aminopeptidases, the collagenases and the calcium and ATP-activiated proteases, each with numerous examples.

Accordingly, in a still further embodiment the at least one enzyme/precursor enzyme is a protease such as, but not limited to, subtilisins, chymotrypsins, trypsins, elastases, cathepsins, papains, chromopapains, pepsins, carboxypeptidase A, carboxypeptidase B, thermolysins, calcium activated proteases, ATP-activated proteases, exopeptidases such as aminopeptidases and carboxypeptidases, endopeptidases, and the like.

One class of preferred enzymes are the subtilisins. Subtilisins are serine endopeptidases. Examples include subtilisin BPN (also known as subtilisin B, subtilopeptidase B, subtilopeptidase C, Nagarse, Nagarse proteinase, subtilisin Novo, bacterial proteinase Novo) and subtilisin Carlsberg (subtilisin A, subtilopeptidase A, alcalase Novo). Now grouped under IUBMB enzyme nomenclature EC 3.4.21.62, formerly EC 3.4.4.16 and included in EC 3.4.21.14. Subtilisin enzymes are produced by various Bacillus subtilis strains and other Bacillus species.

Further examples of subtilisins include, but is not limited to, e.g. alcalase; alcalase 0.6 L; alcalase 2.5 L; ALK-enzyme; bacillopeptidase A; bacillopeptidase B; Bacillus subtilis alkaline proteinase bioprase; bioprase AL 15; bioprase APL 30; colistinase; (see also comments); subtilisin J; subtilisin S41; subtilisin Sendai; subtilisin GX; subtilisin E; subtilisin BL; genenase I; esperase; maxatase; alcalase; thermoase PC 10; protease XXVII; thermoase; superase; subtilisin DY; subtilopeptidase; SP 266; savinase 8.0 L; savinase 4.0 T; kazusase; protease VIII; opticlean; Bacillus subtilis alkaline proteinase; protin A 3 L; savinase; savinase 16.0 L; savinase 32.0 L EX; orientase 10 B; protease S.

Accordingly, one particularly preferred protease is endopeptidases of the subtilisin type (EC 3.4.21.62). Subtilisin type proteases can be applied in the form of a commercially available enzyme preparations such as Alcalase®. Alcalase® is a serine-type protease characterised by a good performance at elevated temperatures and moderate alkalinity. In a presently preferred embodiment the enzyme preparation Alcalase 2.5. L, Type DX® is applied. However it is also contemplated that other Alcalase® products, including Alcalase 2.0T®, Alcalase 3.0 T® and Alcalase 2.5 L, Type DX®, can be applied in accordance with the present invention. Such Alcalase® enzyme preparations are available from Novozymes (Novozymes, Novo Allé, 2880 Bagsvaerd, Denmark).

However, it is also within the scope of the invention that other proteases having essentially the same characteristics as the protease of Alcalase® can be successfully applied in accordance with the invention. Thus, it is contemplated that other proteases, such as subtilisins, having essentially the same temperature and pH profiles as the Alcalase, can be utilised. The temperature and pH profiles of the Alcalase can be found on the product sheet from Novozyme A/S (B259f-GB).

Accordingly, it is within the scope of the invention that a subtilisin type protease (EC 3.4.21.62) having the following characteristica: (i) optimum activity at a pH in the range of about 7 to 10, such as from more than 7.5 to about 10; and (ii) optimum activity at a temperature in the range of from about or more than 55 to about 65° C., may advantageously be applied.

Enzymes/precursor enzymes capable of degrading polysaccharides are generally desirable in combination with an oxidase the activity of which results in the production of peroxide. The reason is that polysaccharide digesting enzymes can break down a polysaccharide component of a microbial adhesive structure and/or degrade important structural polysaccharides of microorganisms into building blocks of preferably mono- and/or disaccharides. Such compounds and precursors thereof are substrates for oxidases and their formation thus enhances the subsequent production of peroxides. Additionally, the polysaccharide digesting enzymes of the present invention can prevent or interfere with the attachment process or the subsequent. growth, metamorphosis or replication of the fouling organisms in question

Accordingly, in a still further embodiment the at least one enzyme/precursor enzyme is a polysaccharide digesting enzyme, such as, but not limited to, alpha-amylase, beta-amylase, beta-glucosidase, glucosidase, glycosidase, cellulase, pectinase, hyaluonidase, beta-glucuronidase.

The enzymes beta-amylase, beta-glucosidase, and glycosidase all belong to the group of enzymes that can degrade polysaccharides. Pectinase and cellulase are enzymes which break down pectin and cellulose, respectively, two ubiquitous structural polymers of the plant cell wall and cell wall connective tissue matrix. Lysozyme and achromopeptidase can also break cell walls, the latter having an exceptional range of activity against microorganisms. Hyaluronic acid and collagen have analogous structural roles in animals and are degraded by hyaluronidase and collagenase, respectively. Beta-Glucuronidase will also break down hyaluronic acid.

Additionally preferred polysaccharide degrading enzymes are “hemicellulolytically active” enzymes, “cellulolytically active” enzymes, and “amylolytically active” enzymes. The the first group belong enzymes such as xylanases, which have the capability to degrade at least one substance belonging to the group of compounds and precursor compounds generally referred to as hemicellulose, including xylans and mannans, such as Endo-1,4-beta-xylanase (E.C. 3.2.1.8), Xylan endo-1,3-beta-xylosidase (E.C. 3.2.1.32), Glucuronoarabinoxylan endo-1,4-beta-xylanase (E.C. 3.2.1.136), Beta-mannosidase (E.C. 3.2.1.25), Mannan endo-1,4-beta-mannosidase (E.C. 3.2.1.78) and Mannan endo-1,6-beta-mannosidase (E.C. 3.2.1.101).

Enzymes having “cellulolytic activity” are also generally referred to as cellulases and is used herein to designate any cellulose hydrolysing enzyme.

“Amylolytically active” enzymes includes, in the present context, amylases, such as α-amylases and β-amylases, amyloglucosidases, pullulanases, α-1,6-endoglucanases, α-1,4-exoglucanases and isoamylases.

The above-mentioned enzymes occur in preferred embodiments in combination with at least one oxidase. Accordingly, when the coating composition comprises an oxidase capable of acting on a compound, wherein said action results in the formation of an antimicobial species, the coating composition can in further embodiments comprise one or more of
at least one esterase from the above group, optionally in the absence of a substrate for said esterase, and/or
at least one lipase from the above group, optionally in the absence of a substrate for said lipase, and/or
at least one protease from the above group, optionally in the absence of a substrate for said protease, and/or
at least one polysaccharide degrading enzyme from the above group, optionally in the absence of a substrate for said enzyme.

Preferred combinations of the above enzymes in combination with the at least one oxidase include
a coating composition comprising at least one oxidase in the absence of a substrate for said oxidase and at least one hydrolytic enzyme, optionally in the absence of a substrate for such a hydrolytic enzyme,
a coating composition comprising at least one oxidase in the absence of a substrate for said oxidase and at least one esterase,
a coating composition comprising at least one oxidase in the absence of a substrate for said oxidase and at least one lipase,
a coating composition comprising at least one oxidase in the absence of a substrate for said oxidase and at least one protease,
a coating composition comprising at least one oxidase in the absence of a substrate for said oxidase and at least one polysaccharide digesting enzyme,
a coating composition comprising at least one oxidase in the absence of a substrate for said oxidase and at least one esterase and at least one lipase,
a coating composition comprising at least one oxidase in the absence of a substrate for said oxidase and at least one esterase and at least one protease,
a coating composition comprising at least one oxidase in the absence of a substrate for said oxidase and at least one esterase and at least one polysaccharide digesting enzyme,
a coating composition comprising at least one oxidase in the absence of a substrate for said oxidase and at least one esterase and at least one lipase and at least one protease,
a coating composition comprising at least one oxidase in the absence of a substrate for said oxidase and at least one esterase and at least one lipase and at least one polysaccharide digesting enzyme,
a coating composition comprising at least one oxidase in the absence of a substrate for said oxidase and at least one esterase and at least one lipase and at least one protease and at least one polysaccharide digesting enzyme,
a coating composition comprising at least one oxidase in the absence of a substrate for said oxidase and at least one lipase and at least one protease,
a coating composition comprising at least one oxidase in the absence of a substrate for said oxidase and at least one lipase and at least one protease and at least one polysaccharide digesting enzyme, and
a coating composition comprising at least one oxidase in the absence of a substrate for said oxidase and at least one protease and at least one polysaccharide digesting enzyme.

In various embodiments, the above coating compositions—in addition to the lack of substrate for the at least one oxidase—also does not comprise any substrate for at least one other enzyme. Accordingly, there are provided embodiments wherein any one of the above-mentioned coating compositions i) does not comprise any substrate for the at least one esterase, when an esterase is present, ii) does not comprise any substrate for the at least one lipase, when a lipase is present, iii) does not comprise any substrate for the at least one protease, when a protease is present, and iv) does not comprise any substrate for the at least one polysaccharide digesting enzyme, when a polysaccharide digesting enzyme is present.

In further embodiments the above coating compositions according to the invention i) do not comprise a substrate for an esterase and a lipase, when at least an esterase and a lipase are present, optionally in combination with further enzymes ii) do not comprise a substrate for an esterase and a protease, when at least an esterase and a protease are present, optionally in combination with further enzymes, iii) do not comprise a substrate for an esterase and a polysaccharide digesting enzyme, when at least an esterase and a polysaccharide digesting enzyme are present, optionally in combination with further enzymes, iv) do not comprise a substrate for an lipase and a protease, when at least a lipase and a protease are present, optionally in combination with further enzymes, v) do not comprise a substrate for a lipase and a polysaccharide digesting enzyme, when at least a lipase and a polysaccharide digesting enzyme are present, optionally in combination with further enzymes, and vi) do not comprise a substrate for a protease and a polysaccharide digesting enzyme, when at least a protease and a polysaccharide digesting enzyme are present, optionally in combination with further enzymes.

In the present invention, the at least one enzyme comprised in the coating composition can be any one or more of a purified enzyme or a crude enzyme. The source of the enzyme includes microorganisms, plants, and animals. When incorporating an enzyme into the coating composition; the enzyme may be directly incorporated or it can be used after modification with another species, or in the form of an immobilized enzyme. Immobilization includes enzymes entrapped in reverse micelles; enzymes modified with lipids or surfactants; enzymes modified with polyethylene glycol; and enzymes immobilized on polymer matrices, among other forms.

It is in one embodiment preferred to include into a coating composition of the invention at least one rosin. Rosins are solid materials that e.g. occur naturally in the oleo rosin of pine trees and is typically derived from the oleo resinous exudate of the living tree, from aged stumps and from tall oil produced as a by-product of kraft paper manufacture.

Rosin compounds have a number of highly desirable properties for use as binders in antifouling paints such as e.g. being fairly non-toxic to humans, being compatible with a large number of other binders and being relatively inexpensive and readily available from natural resources.

Thus, rosins are used in paints as binders, and thereby provide a rather non-toxic alternative to synthetic and more toxic binders such as e.g. polymeric binder components as epoxy, polyvinylacetate, polyvinylbutyrate and polyvinylchloride acetate.

Rosin is typically classed as gum rosin, wood rosin, or as tall oil rosin which indicates its source. The rosin materials can be used unmodified, in the form of esters of polyhydric alcohols, in the form of rosins polymerised through the inherent unsaturation of the molecules or in the form of hydrogenated rosin. Thus, rosin can be further treated by e.g. hydrogenation, dehydrogenation, polymerisation, esterification, and other post treatment processes. Additionally, rosin with e.g. free carboxylic acid groups are capable of reacting with metals and thereby forming rosin metal salts.

Accordingly, the rosin compound of the antifouling paint composition of the present invention is at least one selected from rosins, rosin derivatives, and rosin metal salts. Examples of rosins include tall rosin, gum rosin, and wood rosin. Examples of rosin derivatives include hydrogenated rosins, modified rosins obtained by reacting rosins with maleic anhydride, formylated rosins, and polymerised rosins. Examples of rosin metal salts include zinc rosinates, calcium rosinates, copper rosinates, magnesium rosinates, and products of the reaction of rosins with compounds of other metals.

Rosins of natural origin have the beneficial effect that when used in combination with enzymes, the activity of said enzymes are not substantially affected by the rosins as compared to enzymes in paint compositions prepared with synthetic binders of non-natural origin. Accordingly, it was found that no enzyme activity was present in paint compositions comprising protease and synthetic binders of non-natural origin.

The rosins are furthermore believed to have an immobilising effect on the enzymes and thus preventing the enzymes from being released from the paint composition into the environment.

The composition according to invention comprises a rosin compound wherein the content of the rosin compound is in the range of from about 5 to about 60% by weight. It is preferred that the amount of rosin compound is higher than about 10% such as up to about 20% by weight. However, it is also contemplated that the amount of rosin compound in the composition can be up to about 30%, such as up to about 40%, up to about 50% and up to about 55%. Thus, a pigmented composition according to the invention could advantageously comprise an amount of rosin compound in the range of about 10-30% by weight, and a lacquer composition could comprise up to about 60% of rosin compound by weight.

In addition to the at least one enzyme capable of producing an antifouling species, including an antimicrobial species and means for immobilization thereof, including rosins, as described above, the coating composition of the invention can also comprise additional agents useful for preventing fouling, particularly macrofouling. One such group of agents is termed repellants of the macrofouling organisms. Repellants belong to a group of biologically active compounds which repell rather than attract microbial organisms.

Repellants according to the invention include molecules that are customarily associated with some inimicable material formed by a predator (or other non-compatible organism) of the macrofouling organism. An example is the material customarily excreted by starfish that causes such prey organism as scallops to immediately react to the material and try to escape therefrom. When affixed to a surface as described herein, the repellant would not freely diffuse but would act to elicit the escape response when the organism contacted the surface being protected. An example of this would be a purified chemical repellant or an impure suspension containing the active chemical repellant that is obtained by grinding and partially fractionating a coral or algae preparation. The repellants of choice are those natural products used by corals, seaweeds and other aquatic organisms to avoid fouling of their surfaces.

In addition to natural products that can act as repellants, the surface protection can also be brought about by affixing a surfactant. Some repellants will be surfactants and vice versa, but as surfactants are generally not regarded as repellants in all senses of the word, they are considered as a separate class of bioactive agents having a useful effect in combination with enzymes and/or repellants of this invention.

A surfactant can have an inhibitory effect on attachment of organisms to a surface even when immobilized on or within a coating composition of the invention. Specific examples of immobilized surfactants are cationic, anionic and non-ionic surfactants such as quaternary ammonium ions, dipalmitoyl phosphatidyl choline, aralkyl sulfonates and sucrose esters, respectively. Other examples are set forth in the Kirk-Othmer Encyclopedia of Chemical Technology, Vol. 22, pages 332-432, John Wiley & Sons, New York, 1983.

Yet another example of a compound capable of being incorporated into coating compositions according to the invention is tannic acid, a representative compound of the tannins, a family of compounds secreted by certain species of marine brown algae (e.g. Sargassum), which appear to restrict bacterial colonization of the frond surface (Sieburth and Conover (1965) Nature 208 52). This is exemplary of the class of compounds, useful in non-toxic anti-fouling coatings, that act by interference with enzymatic reactions necessary for attachment of macro- or micro-organisms. Candidate compounds in this category include kojic acid and similar inhibitors of polyphenol oxidase. These inhibitors will interfere with the cross-linking of cement-forming materials of similar value are glucosyl transferase inhibitors which will prevent the formation of polysaccharide adhesives used in adhesion, mutastein, ribocitrin, 1-deoxynojirimycin, acarbose, and N-methyldeoxynojirimycin being exemplary of these.

Antimicrobial Effects of the Coating Composition

The coating compositions of the invention are capable of reducing and/or eliminating fouling in the form of microbial growth and/or the formation of bio-film on objects coated with the composition. The microbial organisms can be e.g. bacteria, vira, fungal cells and slime molds. For aquatic environments, the microbial organisms are marine organisms.

In selecting the at least one enzyme of the coating composition one must take into consideration—among other things—the type of surface being protected, the environment in which the surface is found, and the organism against which protection is being sought.

The general principle underlying the choice of enzyme to be immobilized is that the abundance of a particular type of enzyme should be proportional to the probable frequency of surface contact with the target organism against which the antifouling species, including an antimicrobial species generated by the enzyme has antifouling efficacy.

As an example, a short-term protection against settling organisms in a marine environment can focus on deterring the formation of films that are deposited by the settlement and growth of marine algae and bacteria. In this case, the bioactive materials to be incorporated on the surface can be distributed equally between a bactericide and an algaecide.

Accordingly, the antimicrobial effects of the compositions according to the invention are directed to—among others—the following groups of microbial organisms: Bacteria, fungi, algae, protozoa, porifera, coelenterata, platyhelminthes, nemertea, rotifera, bryozoa, brachiopoda, annelida, arthropoda, mollusca, echinodermata and chordata.

One interesting case is that of preventing growth and/or attachment to a surface of Vibrio species in an aquatic environment. Vibrio species often cluster together due to the presence of an extracellular polysaccharide (slime) that they synthesize. The best-known species of Vibrio is V. cholerae which causes cholera, a severe diarrhoeal disease resulting from a toxin produced by bacterial growth in the gut. Accordingly, the present invention in one preferred aspect also relates to preventing and/or reducing the risk of cholera outbreaks in environments wherein V. cholerae is present. The method includes the step of coating pipes, filters, tanks and the like with a composition according to the invention comprising at least one oxidase and a polysaccharide degrading enzyme capable of degrading polysaccharides secreted by Vibrio species including V. cholerae.

The development of an antifouling species, including an antimicrobial species which could eliminate only, for example, barnacles in an aqueous environment would be solving only part of the fouling problem. Studies on the temporal development of a fouling community have revealed that bacteria are usually the first organisms to colonize a submerged surface. Attached bacteria produce a secondary extracellular polymeric adhesive, and eventually the surface of the substratum becomes coated with bacteria embedded within this extracellular matrix (collectively referred to as a bacterial film).

The rate of subsequent colonization by other microorganisms, and by marine invertebrate larvae, is often dependent upon the initial formation of a bacterial film. Consequently, the development of a coating composition capable of reducing and/or eliminating the process of bacterial film formation can be expected also to have a significant anti-fouling effect.

A small number of proteins and carbohydrates constitute the important structural elements of the cell wall of a wide range of microbial organisms. Collagen, cellulose, and chitin are three abundent structural polymers. Chitin, for example, is an important constitutent of the shell matrix of the inarticulate Brachipoda, the exoskeleton of the Ectoprocta (e.g. Bryozoa), the walls of sponge gemmules (the dispersal stage of the sponge life cycle), the perisarc (the outer layer of the integument) of hydrozoan coelenterates, the cell wall of fungi, and the cuticle of all arthropods. Aditional relevant polysaccharides are mannans, galactomannans, alginates, laminarins, carregeenans (iota and kappa), and agars.

Any enzyme capable of degrading any one or more of the above polymers, including collagen and/or cellulose and/or chitin can therefore be included into the coating composition of the invention, optionally in the absence of a substrate for such an enzyme, and preferably in combination with an oxidase, in the absence of a substrate for said oxidase.

The integument of most fouling organisms is the principal organ of permanent postmetamorphic attachment and adhesion. Interference with the synthesis of an important biochemical constituent of the cell wall or integument, or any degradation of such structural elements or interference with the enzymatic processes involved in adhesion would therefore exert a strong anti-fouling action.

As the bacterial and algae film production can well be a prerequisite for most macrofouling, this term refers to the attachment of organisms larger than unicellular organisms to an aquatic surface. Should this be the case, little or no enzyme or other chemical antifoulant capable of disrupting the attachment process of macrofouling organisms may need to be included as microfouling does not take place.

However, in a region that is heavily populated with barnacle larvae, enzymes which specifically retard the settlement of the barnacle larva would be more important and should be incorporated on a surface, preferably in larger proportion.

The coating compositions according to the invention in one embodiment result in the formation of a monoayer of enzymes located on the surface of an object. For example, an enzyme having a molecular weight of approximately 50,000 daltons would give a monolayer when spaced on a surface with a distance of approximately 40 angstroms between the centers of adjacent molecules. This spacing assumes a Stokes radius of approximately 20 angstroms. However, it is not essential that a complete monolayer is present. A desirable activity can be maintained with the spacing of bioactive compounds over greater distances. A spacing of no more than 1,000 angstroms and more preferably no more than 100 angstroms is preferred in order to insure that a biologically active chemical is available for reaction with a fouling organism at each point of initial contact.

The coating compositions of the invention can be used in all types of environments, including non-aquatic as well as aquatic environemnts, including sea-water, estuary, and fresh water environments. In addition to natural environments (i.e., those which are in free contact with and freely exchange material with other parts of the bio-sphere without human intervention), the term “aquatic environments” as used herein also includes cooling towers, fresh and salt water piping systems, desalination and other filtration systems containing membrane “surfaces” subject to protection, and other aquatic environments which rely upon the intervention of human beings for their creation and maintenance.

As used herein, the term “natural environment” includes ponds, lakes, dredged channels and harbors, and other bodies of water which were initially produced by the action of human beings but which do not rely upon human intervention for the supply of water into and out of such environments.

While many fouling organisms such as barnacles and algae are well known to the general public, those skilled in the art will recognize that the term fouling organism as used herein refers to any living organism which is capable of attaching to a surface in an aquatic environment.

The group of algae are very diverse and probably not related to one another. There are 6 divisions of algae, some unicellular and some multicellular. In some taxonomic schemes, the last three divisions are included in the Kingdom Protista which includes all eukaryotic, unicellular organisms, regardless of their mode of nutrition. Algae can be characterised with repsect to e.g.:
1. Photosynthetic pigments. Some pigments mask the chlorophylls and give their name to the common name of the division—Brown algae. The accessory pigments participate with the PS II reaction center.
2. Food storage chemistry is an important distinguishing feature. Not all organisms store energy in the form of starch as do most plants. There are unique storage chemicals for the various division.
3. Flagella structure is a good distinguishing feature for those division that have flagellated cell. The number of flagella, morphology of the flagellum and its 15 orientation characterize divisions.
4. Cell wall chemistry is another distinguishing feature.
5. Sometimes the habitat for members of the division can be important.

Rhodophyta are the red algae:
1. Pigments—the phycobolins, phycoerythrin and phycocyanin are the pigments that usually mask the chlorophyll a that is common to all algae and the green plants.
2. Food storage materials—Floridean starch is a polysaccharide material.
3. Cell wall materials—The red algae possess a microfibrillar network of polysaccharide material (cellulose or some other) embedded within a mucilaginous matrix such as agar. Some marine forms may produce CaCO₃ in their walls to give them a rigid structure.
4. Types and number of flagella—The red algae never produce motile cells. Not only do they not produce motile cells, it appears that they may never have had motile cells.
5. Habitat—The red algae are mostly marine organisms but a few freshwater types do exist.
6. The life cycles of red algae are complicated by the presence of a third generation type in addition the sporophyte and gametophyte.

Phaeophyta are the brown algae. This group includes the kelps and rockweeds.
1. Pigments—The Brown algae have fucoxanthin as an accessory pigment to mask the chlorophyll a and c, giving them the brownish color.
2. Food storage materials—Lamanarin is a polysaccharide food storage material unique to the brown algae.
3. Cell wall materials include a mucilaginous material called algin that is harvested from kelps.
4. Types and number of flagella—The brown algae have heterokont flagellated cells. One is an anteriorly-oriented tinsel-type flagellum and the other flagellum is a posteriorly-oriented whiplash type.
5. Habitat—The brown algae are all marine organisms.
6. Several life cycle types are exemplified by the brown algae.
   Ectocarpus is a filamentous alga that has an isomorphic alternation of generations.
   Laminaria is a kelp that has a heteromorphic alternation of generations. The gametophyte is microscopic, whereas the sporophyte is macroscopic.
   Fucus is a rockweed that has gametic meiosis. There is no alternation of generations for this organism. The gametangia, antheridia and oogonia, are produced within a conceptacle. Many conceptacles are located on a receptical at the end of the dichotomously branched thallus. Meiosis occurs in the production of the gametes.

Chlorophyta are the green algae. Because of the similarity in pigmentation, cell division, and food storage materials, the land plants are thought to be derived from the Chlorophyta.
1. Pigments—Chlorophyll b is the accessory pigment.
2. Food storage materials are starch.
3. Cell wall materials—are primarily cellulose but some marine forms may add CaCO₃.
4. Types and number of flagella of the chlorophyta are isokonts with whiplash flagella.
5. Habitat of chlorophyta is freshwater and marine.
6. Taxonomy of the chlorophyta is divided into three classes based on method of cell division, insertion of flagella and internal cell structure.
   Method of cell division refers to the production of a phragmoplast. or a phy phycoplast.
   Insertion of flagella are either apical or subapical.
   Internal cell structure refers to the possession of a system of microtubules found near the flagella apparatus. Also the possession of peroxisomes involved in photoresiration.
7. Classes of Chlorophyta
   Charophyceae are the group most like the land plants. They undergo mitosis by formation of a phragmoplast, possess the microtubular system characteristic of land plants, and have subapically inserted flagella. Example organisms in this group are Spyrogyra, the desmids and Coleochaeta.
   The Ulvaphyceae are mostly marine organisms that have an alternation of generation. The life cycle of Ulva has an isomorphic alternation of generations with sporic meiosis. These organisms produce a phycoplast when undergoing cell division and the nuclear envelope persists during division.
   Chlorophyceae produce a phycoplast when undergoing cell division and the nuclear envelope persists during division. There are many forms that have zygotic meiosis like Chlamydamonas.

Chrysophyta are unicellular algae.
1. Characteristics of the Chrysophyta indicate a similarity with the brown algae. There are three classes of chrysophyta.
   Pigments include chlorophyll a and chlorophyll c. These are usually masked by an abundance of a brownish pigment, fucoxanthin.
   Food reserve in the Chrysophyta is called chrysolaminarin—a carbohydrate.
   The cell of chrysophytes may be naked or they may have cell walls of cellulose. Some members have silica scales or shells.
2. Classes of Chrysophyta
   Chrysophyceae are primarily freshwater planktonic organisms. They lack a clearly defined cell wall but have silica scales. Many of these organisms have flagella.
   Bacillariophyceae are the diatoms. These are important phytoplanktonic organisms in freshwater and marine environments. They are characterized by the presence of silica cell walls with intricate markings. They have chlorophyll a and c and fucoxanthin which gives them a brownish color. When they undergo sexual reproduction, the only flagellated cell appears, a males sperm cell. It has two flagella, one whiplash and one tinsel type.
   Xanthophyceae are the yellow green algae because they lack fucoxanthin and the greenish colors show. Vaucheria, which you saw in lab belongs to this class.

Pyrrophyta are important phytoplanktonic organisms in freshwater and marine habitats.
1. Characteristics of Pyrrophyta
   The dinoflagellates contain chlorophyll a and c and a brownish pigment called peridinin.
   The food storage material of the pyrrophyta is starch.
   The cell walls of those that possess them are in the form of cellulosic plates and hence the name armored dinoflagellates given to some members of the phylum.
   The pyrrophyta have two flagella. One flagellum encircles the cell like a belt. The other flagellum trails behind the cell.
2. Features of the dinoflagellates
   Some of these organisms are responsible for the poisonous red tide.
   Some of these organisms are capable of bioluminescence.

Euglenophyta are unicellular algae that lack a cell wall.
1. Characteristics of the Euglenophyta
   The euglenoids posses chlorophyll a and b and carotenoids. They have the same grass green color as the green algae.
   The food storage material of the euglenoids is paramylon, a polysaccharide material
   The euglenophyta lack cell walls. Instead they have a proteinaceous coating called the pellicle. They are capable of changing shape because they lack the cell wall.
   The euglenoids have two flagella but only one flagellum emerges from a gullet at the tip of the cell. The other short flagellum is basically nonfunctional as a swimming aid.

Prevention and/or elimination or at least substantial reduction of microfouling by all or some of the above algae is within the scope of the present invention.

The term microfouling is used to denote the attachment of unicellular organisms, such as bacteria and algae, to the submerged surface. These microfouling organisms can, in some cases, secrete chemical signals which attract further organism to the surface, thereby increasing the rate of fouling. Macrofoulers, such as barnacles, become attached to the surface after the formation of the initial microfouling layer.

As microfouling may occur before the macrofouling, any process which interferes with the attachment of microbial organisms to aquatic surfaces would decrease the total amount of fouling which takes place. Thus, an active ingredient capable of preventing the attachment of barnacles operates at the end of the fouling chain while an active species which operates to prevent the attachment of unicellular organisms such as bacteria operates at the beginning of the fouling chain. Accordingly, species which prevent microfouling may have some inhibitory effect against settlement of all types of fouling. One such particularly preferred antifouling species, including an antimicrobial species is peroxides, such as hydrogen peroxide, produced by oxidases.

Additional antifouling organisms the growth of which is capable of being controlled by the means of the present invention as described herein includes, but is not limited to crustaceans and other marine hard growth, such as:
Tube Worms: polychaetes; phylum Annelida; subclass Eunicea; family Serpulidae
Mussels: bivalves; phylum Mollusca; subclass Pteriomorphia; family Mytilidae
Clams: bivalves; phylum Mollusca; subclass Hterodonta; family Veneridae
Bryozoans: bryozoans; phylum Bryozoa; suborder Anasca and Ascophora; genus Schizoporella
Barnacles: crustaceans; phylum Arthropoda; subphylum Crustacea

However, as is clear from the description herein above, the invention also has utility against soft growth, which can impede e.g. the efficiency of hull forms, damage substrates of marine structures, generally shorten the viable life span of equipment, and escalate the cost of operation. Examples of these soft growth forms include:
Algae (Botanus): Padina, and Codium
Bryozoans (Animal): Bugula Neretina
Hydroids (Animal): Obelia
Sabellids (Animal):
Delaya Marina (Marine Bacteria): Zibria

The compositions, coatings and/or paints may also function by direct attack on the surface film, disrupting its polymeric structure through e.g. hydrolysis of the proteins and polysaccharides of the film. This would interrupt the chain of events that ultimately leads to the accumulation of large amounts of marine organisms (including bacteria, fungi, barnacles, etc.) on e.g. the hull of the ship.

Such attack may be accomplished by the use of extracellular enzymes that disrupt the polysaccharides and proteins that make up the surface film. Key hydrolytic enzymes in this respect are proteases, alpha-amylases, amyloglycosidases and xylanases. Alternatively, the coatings and/or paints may function by modifying the surface tension of the marine surface to which the coatings and/or paints have been applied. Such a change in the surface tension may disrupt the colonization of the surface by undesirable marine organisms.

The methods and compositions disclosed herein may be used on a variety of surfaces, including but not limited to boat hulls, marine markers, bulkheads, pilings, water inlets, floors, roofs, and shingles. For example, the methods and compositions may be used to minimize fouling of marine markers. Such markers constitute a large category of floating objects and are greatly impaired by the accumulation of marine growth.

Similarly, the methods and compositions may be used on marine bulkheads. The accumulation of marine growth on bulkhead structures is detrimental to the bulkhead structure over the long term. Furthermore, the growth causes significant short term effects that are aesthetically displeasing and dangerous. Moreover, the harsh abrasive characteristics of the hard growth can result in major damage to vessels.

Similarly, the present invention can be used to minimize blockages due to fouling by marine growth of heat exchangers, evaporators, condensers and fire and flushing systems, thus resulting in significant decreases in maintenance costs for all categories of marine structures.

Compositions and/or paints according to the invention may include various hydrolytic enzymes, although it is possible to practice the invention without such hydrolytic enzymes. Examples of suitable enzymes include proteases, including subtilisins such as e.g. alcalase, amylases, amyloglycosidases, xylanases and other hydrolytic enzymes known in the art. The hydrolytic enzymes selected should act to prevent or reduce attachment by unwanted or undesirable marine organisms. The hydrolytic enzymes chosen should be able to survive and flourish in the marine environment to which they will be exposed.

Compositions and/or paints according to the invention include the above-mentioned enzymes in an amount effective to reduce the growth of unwanted or undesirable microorganisms. Such compositions and/or paints may be in a variety of forms, including paints, lacquers, pastes, laminates, epoxies, resins, waxes, gels, and glues in addition to other forms known to one of skill in the art.

The compositions and/or paints may be polymeric, oligomeric, monomeric, and may contain cross-linkers or cure promoters as needed. Such compositions and/or paints may contain other additives, in addition to those mentioned above, to accomplish purposes known to one of skill in the art. Such other additives include preservatives, pigments, dyes, fillers, surfactants, and other additives known to one of skill in the art.

Selected Antifouling Species

Peroxides in general constitute one much preferred group of antifouling species, including an antimicrobial species according to the invention. Hydrogen peroxide is an example of a presently most preferred antifouling species, including an antimicrobial species.

Additional preferred species having antimicrobial activity includes, but is not limited to, carboxyl group-containing species, hydroxyl group-containing species, amino group-containing species, aldehyde group-containing species, and decomposition products of chitosan.

Any enzyme-compound combination capable of producing hydrogen peroxide can be used, including a combination wherein the enzyme is an oxidase and the compound can be oxidized by said oxidase.

A combination of said oxidase with said compounds to be oxidized thereby includes such combinations as malate oxidase-malic acid; glucose oxidase-glucose; hexose oxidase-glucose; cholesterol oxidase-cholesterol; arylalcohol oxidase-arylalcohol: galactose oxidase-galactose; alcohol oxidase-alcohol; lathosterol oxidase-lathosterol; aspartate oxidase-aspartic acid; L-amino-acid oxidase-L-amino acid; D-amino-acid oxidase-D-amino acid; amine oxidase-amine; D-glutamate oxidase-glutamine; ethanolamine oxidase-ethanolamine; NADH oxidase-NADH; urate oxidase (uricase)-uric acid; superoxide dismutase-superoxide radical; and so forth.

The enzymatic reaction between said oxidase and the compound yields hydrogen peroxide. The enzymatic reaction can proceed when either oxygen or oxygen and water are present in an external environment contacting the coating composition according to the invention.

The above-mentioned oxygen is supplied not only from atmospheric air but also from e.g. seawater containing dissolved oxygen. The enzymatic reaction of the invention occurs in an external environment including seawater with the result that hydrogen peroxide is produced in said environment.

The carboxyl group-containing species includes a variety of organic acid species, e.g. aliphatic acids such as formic acid, acetic acid, propionic acid, butyric acid, caproic acid, caprylic acid, capric acid, lauric acid, myristic acid, palmitic acid, oleic acid, linoleic acid, linolenic acid, monochloroacetic acid, monofluoroacetic acid, sorbic acid, undecylenic acid, etc.; dibasic acids such as oxalic acid etc.; aromatic carboxylic acids such as benzoic acid, p-chlorobenzoic acid, p-hydroxybenzoic acid, salicylic acid, cinnamic acid, etc.; and their derivatives and halides. Any enzyme-compound combination capable of producing a carboxyl group-containing species can be applied.

The ester bond-containing species mentioned above is not particularly restricted in kind but includes, among others, esters of any of said carboxyl group-containing species with aliphatic alcohols such as methyl alcohol, ethyl alcohol, propyl alcohol, butyl alcohol, pentyl alcohol, caproyl alcohol, caprylyl alcohol, capryl alcohol, lauryl alcohol, myristyl alcohol, palmityl alcohol, oleyl alcohol, etc.; esters of any of said carboxyl group-containing species with aromatic alcohols such as phenol, benzyl alcohol, etc.; esters of any of said carboxyl group-containing species with polyhydric alcohols such as ethylene glycol, glycerol, etc.; and esters of any of said carboxyl. group-containing species with derivatives or halides of said aliphatic alcohols, aromatic alcohols, or polyhydric alcohols.

The ester bond-containing species mentioned above is hydrolyzed by said esterase in the above-mentioned coating composition to produce said carboxylic group-containing species. This enzymatic reaction can proceed when water is present in the reaction system, as follows.
R₁COOR₂+H₂O═>R₁COOH+R₂OH

In the above reaction scheme, R₁ represents carboxylic residue and R₂ represents an alcohol residue.

When the above coating composition is applied to an object, the antimicrobial effect is achieved when e.g. moisture from the atmosphere is provided to the reaction resulting in the production of an antifouling species, including an antimicrobial species. When the coating composition is applied to an object to be placed in an aqueous environemnt e.g. in water such as seawater, the reaction resulting in the production of antifouling species, including an antimicrobial species takes place in said water.

The amide bond-containing species mentioned above includes, but is not limited to, amides of any of said carboxyl group-containing species with aliphatic amines such as butylamine, hexylamine, octylamine, decylamine, laurylamine, stearylamine, oleylamine, etc.; and amides of any said carboxyl group-containing species with aromatic amines such as aniline, toluidine, xylidine, and alkylanilines such as hexylaniline, octylaniline, nonylaniline, dodecylaniline, and so forth.

The hydroxyl group-containing species mentioned above includes, but is not limited to, aliphatic alcohols such as methyl alcohol, ethyl alcohol, propyl alcohol, isopropyl alcohol, butyl alcohol, isobutyl alcohol, pentyl alcohol, isopentyl alcohol, hexyl alcohol, etc.; aromatic alcohols such as phenol, chlorophenol, and alkylphenols such as cresol, xylenol, etc., resorcinol, benzyl alcohol, etc.; and the derivatives and halides of said aliphatic or aromatic alcohols.

Any enzyme-compound combination capable of producing the hydroxyl group-containing species can be applied. In one embodiment, the enzyme is an esterase and the compound is an ester bond-containing species. The esterase and the ester bond-containing species includes the species mentioned hereinbefore, but is not limited to these species.

The amino group-containing species mentioned above includes, but is not limited to aliphatic amines such as butylamine, hexylamine, octylamine, decylamine, laurylamine, stearylamine, oleylamine, cyclohexylamine, etc.; and aromatic amines such as aniline, toluidine, xylidine, p-n-hexylaniline, p-n-octylaniline, p-nonylaniline, p-dodecylaniline, and so forth.

Any enzyme-compound combination capable of producing said amino group-containing species can be used. Preferred is the case in which the enzyme is an amidase including a protease, and the compound is an amide bond-containing species including apolypeptide. The amidase and the amide bond-containing species includes the species mentioned hereinbefore, but is not limited to these species.

The aldehyde group-containing species includes, but is not limited to aliphatic aldehydes such as formaldehyde, glyoxal, succinaldehyde, glutaraldehyde, capronaldehyde, caprylaldehyde, caprinaldehyde, laurinaldehyde, stearinaldehyde, oleinaldehyde, etc.; benzaldehyde and its derivatives such as p-n-hexylbenzaldehyde, p-octylbenzaldehyde, p-oleylbenzaldehyde, vaniline, piperonal, etc.; salicylaldehyde, cinnamaldehyde, and so forth.

Any enzyme-compound combination capable of producing said aldehyde group-containing species can be used, including the case in which the enzyme is alcohol dehydrogenase and the compound is an aliphatic alcohol, e.g. methanol, ethanol, etc.; the case in which the enzyme is alcohol oxidase and the compound is an aliphatic alcohol such as methanol, ethanol, etc.; the case in which the enzyme is arylalcohol dehydrogenase and the compound is an aromatic alcohol such as phenol, cresol, etc.; and the case in which the enzyme is amine oxidase and the compound is an aliphatic amine such as butylamine, hexylamine, and so forth.

Any enzyme-compound combination capable of producing a decomposition product of chitosan can be applied. Preferred is the case in which the enzyme is a chitosan-decomposing enzyme and the compound is chitosan.

Additional Components of Coating Compositions of the Invention

The coating compositions of the invention described herein above can further comprise a binder to immobilise at least one of the constituents, optionally to immobilise the enzymes.

The coating compositions of the present invention can be formulated as coatings, lacquers, stains, enamels and the like, hereinafter referred to generically as “coating(s)”.

Preferably, the coating composition is formulated for treatment of a surface selected from outdoor wood work, external surface of a central heating system, and a hull vehicle should not interfere with the activity of the at least one enzyme(s) and/or any additional antifoulant compound.

Suitable solvents for coating compositions are disclosed e.g. in U.S. Pat. No. 5,071,479 and include water and organic solvents including aliphatic hydrocarbons, aromatic hydrocarbons, such as xylene, toluene, mixtures of aliphatic and aromatic hydrocarbons having boiling points between 100° C. and 320° C., preferably between 150° C. and 230° C.; high aromatic petroleum distillates, e. g., solvent naptha, distilled tar oil and mixtures thereof; alcohols such as butanol, octanol and glycols; yegetable and mineral oils; ketones such as acetone; petroleum fractions such as mineral spirits and kerosene, chlorinated hydrocarbons, glycol esters, glycol ester ethers, derivatives and mixtures thereof.

The solvent may be apolar or polar, such as water, optionally in admixture with an oily or oil-like low-volatility organic solvent, such as the mixture of aromatic and aliphatic solvents found in white spirits, also commonly called mineral spirits.

The solvent may typically contain at least one of a diluent, an emulsifier, a wetting agent, a dispersing agent or other surface active agent. Examples of suitable emulsifiers are disclosed in U.S. Pat. No. 5,071,479 and include nonylphenol-ethylene oxide ethers, polyoxyethylene sorbitol esters or polyoxyethylene sorbitan esters of fatty acids, derivatives and mixtures thereof.

Any suitable surface coating material may be incorporated in the composition and/or coating of the present invention. Examples of trade-recognized coating materials are polyvinyl chloride resins in a solvent based system, chlorinated rubbers in a solvent based system, acrylic resins and methacrylate resins in solvent based or aqueous systems, vinyl chloride-vinyl acetate copolymer systems as aqueous dispersions or solvent based systems, butadiene copolymers such as butadiene-styrene rubbers, butadiene-acrylonitrile rubbers, and butadiene-styrene-acrylonitrile rubbers, drying oils such as linseed oil, alkyd resins, asphalt, epoxy resins, urethane resins, polyester resins, phenolic resins, derivatives and mixtures thereof.

The composition and/or coating of the present invention may contain pigments selected from inorganic pigments, such as titanium dioxide, ferric oxide, silica, talc, or china clay, organic pigments such as carbon black or dyes insoluble in sea water, derivatives and mixtures thereof.

The coating composition of the present invention can also contain plasticisers, rheology characteristic modifiers, other conventional ingredients and mixtures thereof.

The coating composition of the present invention optionally further comprise an adjuvant conventionally employed in compositions used for protecting materials exposed to an aquatic environment. These adjuvants may be selected from additional fungicides, auxiliary solvents, processing additives such as defoamers, fixatives, plasticisers, UV-stabilizers or stability enhancers, water soluble or water insoluble dyes, color pigments, siccatives, corrosion inhibitors, thickeners or antisettlement agents such as carboxymethyl cellulose, polyacrylic acid or polymethacrylic acid, anti-skinning agents, derivatives and mixtures thereof.

In one aspect the present invention provides a marine anti-foulant comprising the coating composition as described above. Preferably, the anti-foulant is self-polishable.

In one aspect of the present invention, the enzyme is preferably encapsulated, such as encapsulated by a semi-permeable membrane. One type of enzymes may be encapsulated individually independently of other types of enzymes, or the enzymes may be encapsulated together. The encapsulating material may be selected such that on contact with a foulant, the enzyme may be released. In this way, a composition may be provided which only provides an anti-foulant species or increases provision of an anti-foulant compound when contacted with a foulant. Alternating layers of anti-foulant species and encapsulation material ensures a sequential release of enzymes.

The composition of the present invention can be provided as a ready-for-use product or as a concentrate. The ready-for-use product may be in the form of an aqueous solution, aqueous dispersion, oil solution, oil dispersion, emulsion, or an aerosol preparation. The concentrate can be used, for example, as an additive for coating, or can be diluted prior to use with additional solvents or suspending agents.

An aerosol preparation according to the invention may be obtained in the usual manner by incorporating the composition of the present invention comprising or dissolved or suspended in, a suitable solvent, in a volatile liquid suitable for use as a propellant.

As discussed in U.S. Pat. No. 5,071,479, the coating composition of the present invention can also include additional ingredients known to be useful in preservatives and/or coatings. Such ingredients include fixatives such as carboxymethylcellulose, polyvinyl alcohol, paraffin, co-solvents, such as ethylglycol acetate and methoxypropyl acetate, plasticisers such as benzoic acid esters and phthlates, e. g., dibutyl phthalate, dioctyl phthalate and didodecyl phthalate, derivatives and mixtures thereof. Optionally dyes, color pigments, corrosion inhibitors, chemical stabilizers or siccatives (dryers) such as cobalt octate and cobalt naphthenate, may also be included depending on specific applications.

The composition and/or coating of the present invention can be applied by any of the techniques known in the art including brushing, spraying, roll coating, dipping and combinations thereof.

Compositions of the present invention can be prepared simply by mixing the various ingredients at a temperature at which they are not adversely affected. Preparation conditions are not critical. Equipment and methods conventionally employed in the manufacture of coating and similar compositions can be advantageously employed.

Preferred Methods and Uses of the Invention

Preferred uses of the present invention include the following methods, but is not limited thereto:

Method for treating a surface contacted by fouling organisms, or a surface at risk of such contact, said method comprising the steps of contacting the surface with a composition according to the invention with an effective amount of said composition or coating composition, wherein said contacting results in eliminating said fouling or at least reducing said fouling.

Method for preventing or reducing fouling of a surface, said method comprising the steps of contacting the surface with a composition according to the invention with an effective amount of said composition or coating composition or hygienic composition, wherein said contacting results in preventing or reducing fouling of said surface.

Method for treating a surface contacted by a fluid composition comprising fouling organisms, said method comprising the steps of contacting the surface with a composition according to the invention with an effective amount of said composition or coating composition, wherein said contacting prevents fouling of said surface, or results in a reduced fouling of said surface.

The above-mentioned surfaces can be at least partly submerged in seawater, or they can be interior or exterior surfaces of a pipe for ventilation, or interior walls in a building.

Additional methods in accordance with the present invention are:

Method for disinfecting a surface, said method comprising the steps of contacting the surface with a composition according to the invention with an effective amount of said composition or coating composition or hygienic composition, wherein said contacting results in a disinfection of said surface.

Method for removing microbial organisms from a surface, said method comprising the steps of contacting the surface with a composition according to the invention with an effective amount of said composition or coating composition or hygienic composition, wherein said contacting results in removing microbial organisms from said surface.

Method for coating an object, said method comprising the steps of contacting the surface with a composition according to the invention with an effective amount of said composition or coating composition or hygienic composition, wherein said contacting results in coating said object.

Method for sealing a surface, said method comprising the steps of contacting the surface with a composition according to the invention with an effective amount of said composition or coating composition or hygienic composition, wherein said contacting results in sealing said surface from an external environment.

Method for reducing or eliminating marine corrosion, said method comprising the steps of contacting the surface with a composition according to the invention with an effective amount of said composition or coating composition or hygienic composition, wherein said contacting results in reducing or eliminating marine corrosion.

Method for preserving a surface, said method comprising the steps of contacting the surface with a composition according to the invention with an effective amount of said composition or coating composition or hygienic composition, wherein said contacting results in preserving said surface.

Method for killing undesirable microbial cells, said method comprising the steps of contacting the surface with a composition according to the invention with an effective amount of said composition or coating composition or hygienic composition, wherein said contacting results in killing undesirable microbial cells.

Method for generating an antifouling species, said method comprising the steps of providing a composition comprising at least one enzyme capable of acting on a compound, wherein said action results in the formation of an antifouling species comprising an antifouling activity, wherein said compound does not form part of said composition, further providing said compound, and forming said antifouling species by contacting said at least one enzyme with said compound.

Method for preparing a painting composition according to the invention, said method comprising the steps of providing at least one pigment and at least one enzyme capable of acting on a compound, wherein said action results in the formation of an antifouling species comprising an antifouling activity, wherein said compound does not form part of said composition, further providing a carrier for said at least one enzyme, and forming said composition by contacting said at least one enzyme with said carrier.

Preferred uses of the invention include, but is not limited to:

Use of at least one enzyme comprising an oxidase activity in the manufacture of a coating composition, wherein said coating composition does not comprise any substrate for said oxidase activity.

Use of at least one enzyme comprising an oxidase activity in a cleaning in place system, wherein said system does not comprise any substrate for said oxidase.

### EXAMPLES

Enzyme Source.

The enzymes with oxidase activity are obtained from commercial sources. These enzymes belong to the class EC 1.1.3. The oxidases are either produced from fermentation of a microorganism (that can be genetically modified) isolated from plant or animal material.

A common denominator for some of these enzymes is that they can produce hydrogen peroxide acting on a carbohydrate as substrate.

An example of an oxidase is Novozym 37007, which is a commercial glucose oxidase product from Novozymes (Novozymes A/S, Denmark). The. enzyme is isolated from the fungus Aspergillus niger

### Example 1

Oxidase compatibility with different paint binders listed in Table 1 was tested. In this example, the oxidase Novozym 37007 from Novozymes was used.

TABLE 1

| | % Oxidase on | | Non volatile |
|---|---|---|---|
| Binder type | non volatile | Solvent | content % |
| Polyvinyl acetate | 5% | Water | 65% |
| Acrylic | 5% | Water | 46% |
| Polyurethane | 5% | Water | 30% |
| Rosin | 5% | Water | 50% |
| Water born alkyd | 5% | Water | 45% |

The oxidase was mixed with each of the binders at a concentration of 5% w/w. The mixture was applied onto a plastic film with a paint applicator. After the binder-enzyme complex had dried the appearance of the mixture was evaluated visually.

The visual evaluation of the dry film showed that the binder-enzyme on the plastic film had a transparent appearance for all five binder-enzyme complexes mentioned in table 1.

These results indicate that the oxidase is compatible with the binders mentioned in table 1 since non-transparent appearance of the film could not be detected. Non-transparency of the film would indicate that a chemical reaction had taken place between the binder and the enzyme resulting in inactivation of the enzyme.

### Example 2

Protein Measurement

After drying and visual evaluation of the plastic film the individual binder-enzyme complex films are cut into small pieces and put into test tubes each containing 5 ml of buffer (pH 8.2). The test tubes are incubated at room temperature for minimum 30 minutes. Following incubation the protein content is determined using the Bio-Rad assay (Bio-Rad Laboratories GmbH, 8000 Munich, Germany).

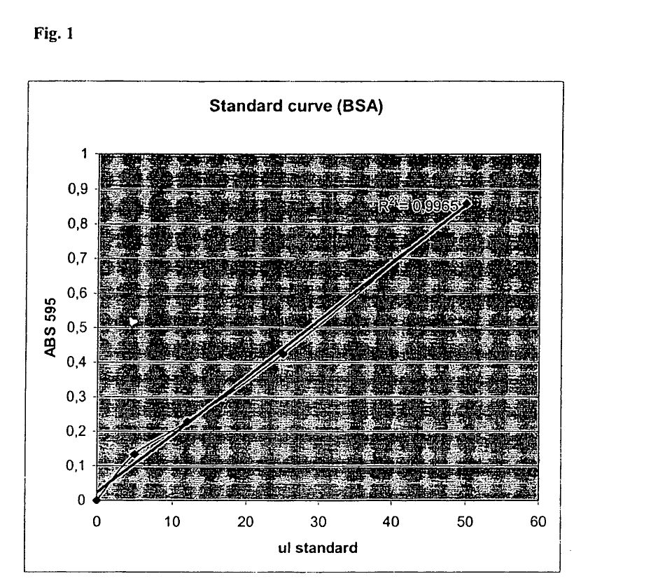

Fifty ul of the solution from the test tubes are transferred into a clean test tube and 2.5 ml of diluted Bio-Rad substrate is added and incubated at room temperature for at least ten minutes. Bovine serum albumin (BSA) is used as standard and a standard curve prepared according to the manufacturers description (FIG. 1). The standards and samples are measured using a spectrophotometer at 595 nm in replicate.

The protein assay reveals that protein canbe detected in all the test tubes analysed expect for the control test tubes where no enzyme had been added to the binders.

### Example 3

Oxidase Activity

To test the oxidase activity enzyme is obtained from the test tubes containing the plastic film cut in pieces exactly as described in Example 2 above.

Into a clean test tube a 0.1% starch solution adjusted to neutral pH id added. Thereafter 100 ul of oxidase containing solution released from the binder-enzyme complex was added. Finally a small amount of amylase is added and the test tubes incubated at room temperature for 30 minutes

After incubation an assay is made to see if hydrogen peroxide could be detected. The peroxide activity—indicating oxidase activity—is assayed using the peroxide test kit from Merck (Merckoquant 10.011).

Peroxide activity can be detected in all the test tubes except from those test tubes where no enzyme has been added to the binder.

### Example 4

Test of Oxidase in Field Experiment

Field experiments are performed in seawater in order to test the efficiency of a paint composition comprising oxidases with or without the combination of other commercially available types of enzyme preparations (proteases and carbohydrases). Accordingly, two paint formulations containing enzymes are prepared; respectively a solvent-based paint and a water borne paint.

The solvent-based paint contains the following components; Natural rosin hydrogenated (20 wt %), acryl resin (20 wt %), dispersion agent (0.75 wt %), titandioxid, dolomit (10 wt %), talcum powder (1.25 wt %), aromatic hydrocarbon (3 wt %) and polyvinylmethylether 5.0 wt %).

The water borne paint contains the following components; Polyvinylacetate (13 wt %), dispersion agent (0.75 wt %), titandioxid (10.0 wt %), dolomit (40.0 wt %), talcum powder (1.25 wt %), natural rosin (13.0 wt %) and water (11.0 wt %).

Paint compositions comprising a protease, a polysaccharide degrading enzyme, and an oxidase are preferred. The following enzymes can be applied:
Alcalase: (Alcalase 2.5 L Type DX®, Novozymes A/S, Denmark)
AMG: (AMG 300 L, Novozymes A/S, Denmark)
Novozym: (Novozym 37007, Novozymes A/S, Denmark)

Alternatives to Alcalase are subtilisins in general.

Alternatives to AMG are amyloglycolytic enzymes in general.

Alternatives to Novozym includes, but is not limited to, hexose oxidase from Chondrus cripus as disclosed in WO 00/75293; “Glyzyme Mono 10.000 BG”, a glucose oxidase purified from Aspergillus niger and produced in a genetically modified strain of Aspergillus oryzae; as well as “Suberase”, a phenol oxidase. The latter two examples are available from Novozymes.

Yet another alternative is a glucose oxidase recombinantly produced by Aspergillus niger, available from CN Biosciences, Calbiochem-Novabiochem Corp., 10394 Pacific Center Court, San Diego, Calif. 92121, U.S.A.

Enzymes are added to the paint formulations in concentrations between 1-10% w/w (total amount). The individual enzymes, such as e.g. protease, polysaccharide degrading enzyme, and oxidase, can be present in amounts of from 1-95% (w/w) of the total amount. Oxidase is preferably present in an amount of from 5-90% (w/w) of the total amount of enzyme present in the paint formulations.

Preferred ratios/amounts (% (w/w)) of enzymes are as follows, where:
A: protease
B: polysaccharide degrading enzyme
C: oxidase
A:B:C: 90:5:5; 85:10:5; 80:15:5; 75:20:5; 70:25:5; 65:30:5; 60:35:5; 55:40:5; 50:45:5; 45:50:5; 40:55:5; 35:60:5; 30:65:5; 25:70:5; 20:75:5; 15:80:5; 10:85:5; 5:90:5; 80:10:10; 70:20:10; 60:30:10; 50:40:10; 40:50:10; 30:60:10; 20:70:10; 10:80:10; 70:10:20; 60:20:20; 50:30:20; 40:40:20; 30:50:20; 20:60:20; 10:70:20; 60:10:30; 50:20:30; 40:30:30; 30:40:30; 20:50:30; 10:60:30; 50:10:40; 40:20:40; 30:30:40; 20:40:40; 10:50:40; 40:10:50; 30:20:50; 20:30:60; 10:40:50; 30:10:60; 20:20:60; 10:30:60; 20:10:70; 10:20:70; and 10:10:80.

In other preferred embodiments, protease is present in from 10-50% (w/w), polysaccharide degrading enzyme is present in from 10-50% (w/w), and oxidase is present in from 10-50% (w/w), with the proviso that the sum of all three enzymes add up to 100% (w/w) of the total enzyme present (1-10% (w/w) of total paint composition).

Sand-blasted acrylic plates (10×20×0.5 cm) are painted with one of the two solvent type marine paint formulations with a surface layer of approximately 130 cm 2, and with a film thickness of 100 micron for the solvent based paint and 85 micron for the water borne paint.

After drying, the panels are mounted on a raft with 5×3 panels. The rafts are immersed into seawater in Elsinore harbour in Denmark. The rafts are immersed in such a way that the upper part of the panel is approximately 1 meter below the water surface. The rafts are inspected monthly.

At the end of the period the panels are taken into the laboratory and evaluated for fouling activity.

Antifouling efficiency is evaluated according to the following table 2:

TABLE 2

0 = no fouling
1 = 10% of the panel fouled
2 = 25% of the panel fouled
3 = 50% of the panel fouled
4 = 75% of the panel fouled
5 = 100% of the panel fouled

No distinctions were made between animal and/or algae/bacterial fouling (slime) in evaluating the panels.

The results of the evaluation can be seen in table 3

TABLE 3

| Panel | Evaluation |
|---|---|
| Panel without paint | 5 |
| Commercial cupper based paint | 0-1 |
| Oxidase denatured | 4-5 |
| Oxidase | 2-3 |
| Oxidase + carbohydrase | 1-2 |
| Oxidase + protease | 1-2 |
| Oxidase + carbohydrase + protease | 1-2 |

From table 3 it can be seen that adding oxidase in a denatured form to the paint had no effect on the antifouling efficiency. Some antifouling efficiency could be obtained by adding only the oxidase enzyme to the paint. Adding a second enzyme clearly increased the antifouling efficiency to an acceptable level.

No distinction can be made between the solvent-based paint and the water borne painted panels in terms of antifouling efficiency.

The panels are inspected for cracks and holes with a magnifying glass (4×). The surfaces of the solvent-based painted panels are still fully intact after several months in seawater. No cracks and holes can be detected. However, the water borne painted panels show some cracks and holes where the fouling can be detected.

1. A coating composition comprising a pigment in combination with at least one enzyme capable of acting on a compound, wherein said action results in the formation of an antifouling species comprising an antifouling activity, and wherein said compound does not form part of said composition.

2. Composition according to claim 1, wherein the enzyme comprises an oxidase activity.

3. Composition according to claim 2, wherein the activity of the oxidase results in the formation of a peroxide.

4. Composition according to claim 3, wherein said peroxide is hydrogen peroxide.

5. Composition according to claim 1, wherein said enzyme is not a haloperoxidase.

6. Composition according to claim 1, wherein said antifouling species does not comprise a halogen, including Cl, Br and I.

7. Composition according to any of claims 1 to 6, wherein the compound comprises or consists of a saccharide part capable of being reduced.

8. Composition according to claim 7, wherein the compound is selected from the group consisting of glucose, an amino acid, galactose, lactose, 2-deoxyglucose, and a pyranose, including any mixture thereof.

9. Composition according to claim 8, wherein the compound is glucose, maltose, lactose and cellobiose.

10. Composition according to claim 8, wherein the compound is glucose.

11. Composition according to any of claims 7 to 10, wherein the enzyme is selected from the group consisting of malate oxidase; glucose oxidase; hexose oxidase; cholesterol oxidase; arylalcohol oxidase: galactose oxidase; alcohol oxidase; lathosterol oxidase; aspartate oxidase; L-amino-acid oxidase; D-amino-acid oxidase; amine oxidase; D-glutamate oxidase; ethanolamine oxidase; NADH oxidase; urate oxidase (uricase); and superoxide dismutase.

12. Composition according to any of claims 7 to 10, wherein the enzyme comprises hexose oxidase activity.

13. Composition according to any of claims 11 and 12, wherein the enzyme is isolated from Chondrus cripus.

14. Composition according to any of claims 7 to 13 further comprising at least one precursor enzyme capable of digesting a precursor compound.

15. Composition according to claim 14, wherein the precursor enzyme is a polysaccharide digesting enzyme.

16. Composition according to claim 15, wherein the polysaccharide digesting enzyme comprises a hemicellulolytic activity.

17. Composition according to claim 15, wherein the polysaccharide digesting enzyme comprises a cellulolytic activity.

18. Composition according to claim 15, wherein the polysaccharide digesting enzyme comprises an amylolytic activity.

19. Composition according to claim 15, wherein the substrate for said polysaccharide digesting enzyme is selected from the group consisting of cellulose, hemicellulose, and chitin.

20. Composition according to claim 19, wherein the substrate for said polysaccharide digesting enzyme does not form part of the composition.

21. Composition according to any of claims 1 to 6 further comprising a protease.

22. Composition according to claim 21, wherein the protease is subtilisin type protease.

23. Composition according to claim 21, wherein the protease is alcalase.

24. Composition according to any of claims 21 to 23, wherein the substrate for said protease does not form part of the composition.

25. Composition according to any of claims 1 to 6, wherein the composition further comprises a lipase.

26. Composition according to claim 25, wherein the substrate for said lipase does not form part of the composition.

27. Composition according to any of claims 1 to 6, wherein the composition further comprises an esterase.

28. Composition according to claim 27, wherein the substrate for said esterase does not form part of the composition.

29. Composition according to any of claims 14 to 20, wherein the composition further comprises a protease.

30. Composition according to claim 29, wherein the protease is of the subtilisin type.

31. Composition according to claim 29, wherein the protease is alcalase.

32. Composition according to any of claims 29 to 31, wherein the substrate for said protease does not form part of the composition.

33. Composition according to any of claims 29 to 32, wherein the protease is a precursor enzyme the activity of which results in the formation of a compound.

34. Composition according to any of claims 14 to 20, wherein the composition further comprises a lipase.

35. Composition according to claim 34, wherein the substrate for said lipase does not form part of the composition.

36. Composition according to any of claims 29 to 33, wherein the composition further comprises a lipase.

37. Composition according to claim 36, wherein the substrate for said lipase does not form part of the composition.

38. Composition according to any of claims 14 to 20, wherein the composition further comprises an esterase.

39. Composition according to claim 38, wherein the substrate for said esterase does not form part of the composition.

40. Composition according to any of claims 29 to 33, wherein the composition further comprises an esterase.

41. Composition according to claim 40, wherein the substrate for said esterase does not form part of the composition.

42. Composition according to any of claims 36 and 37, wherein the composition further comprises an esterase.

43. Composition according to claim 42, wherein the substrate for said esterase does not form part of the composition.

44. Composition according to any of claims 1 to 3, wherein the composition further comprises a rosin.

45. Composition according to any of claims 1 to 3, wherein the composition further comprises a repellant.

46. Composition according to any of claims 1 to 3, wherein the composition further comprises a surfactant.

47. Composition according to any of claims 1 to 3, wherein the composition further comprises tannic acid.

48. Composition according to any of claims 12 to 18, wherein the composition further comprises a rosin.

49. Composition according to any of claims 12 to 18, wherein the composition further comprises a repellant.

50. Composition according to any of claims 12 to 18, wherein the composition further comprises a surfactant.

51. Composition according to any of claims 12 to 18, wherein the composition further comprises tannic acid.

52. Composition according to any of claims 1 to 51 further comprising a fragrance.

53. Method for treating a surface contacted by fouling organisms, or a surface at risk of such contact, said method comprising the steps of contacting the surface with a composition according to any of claims 1 to 52 with an effective amount of said composition or coating composition, wherein said contacting results in eliminating said fouling or at least reducing said fouling.

54. Method for preventing or reducing fouling of a surface, said method comprising the steps of contacting the surface with a composition according to any of claims 1 to 52 with an effective amount of said composition or coating composition or hygienic composition, wherein said contacting results in preventing or reducing fouling of said surface.

55. Method for treating a surface contacted by a fluid composition comprising fouling organisms, said method comprising the steps of contacting the surface with a composition according to any of claims 1 to 52 with an effective amount of said composition or coating composition, wherein said contacting prevents fouling of said surface, or results in a reduced fouling of said surface.

56. Method of any of claims 53 to 55, wherein the surface is at least partly submerged in seawater.

57. Method of any of claims 53 to 55, wherein the surface is the interior or exterior of a pipe for ventilation.

58. Method of any of claims 53 to 55, wherein the surface is an interior wall.

59. Method for disinfecting a surface, said method comprising the steps of contacting the surface with a composition according to any of claims 1 to 52 with an effective amount of said composition or coating composition or hygienic composition, wherein said contacting results in a disinfection of said surface.

60. Method for removing microbial organisms from a surface, said method comprising the steps of contacting the surface with a composition according to any of claims 1 to 52 with an effective amount of said composition or coating composition or hygienic composition, wherein said contacting results in removing microbial organisms from said surface.

61. Method for coating an object, said method comprising the steps of contacting the surface with a composition according to any of claims 1 to 52 with an effective amount of said composition or coating composition or hygienic composition, wherein said contacting results in coating said object.

62. Method for sealing a surface, said method comprising the steps of contacting the surface with a composition according to any of claims 1 to 52 with an effective amount of said composition or coating composition or hygienic composition, wherein said contacting results in sealing said surface from an external environment.

63. Method for reducing or eliminating marine corrosion, said method comprising the steps of contacting the surface with a composition according to any of claims 1 to 52 with an effective amount of said composition or coating composition or hygienic composition, wherein said contacting results in reducing or eliminating marine corrosion.

64. Method for preserving a surface, said method comprising the steps of contacting the surface with a composition according to any of claims 1 to 52 with an effective amount of said composition or coating composition or hygienic composition, wherein said contacting results in preserving said surface.

65. Method for killing undesirable microbial cells, said method comprising the steps of contacting the surface with a composition according to any of claims 1 to 52 with an effective amount of said composition or coating composition or hygienic composition, wherein said contacting results in killing undesirable microbial cells.

66. Method for generating an antifouling species, said method comprising the steps of providing a composition comprising at least one enzyme capable of acting on a compound, wherein said action results in the formation of an antifouling species comprising an antifouling activity, wherein said compound does not form part of said composition, further providing said compound, and forming said antifouling species by contacting said at least one enzyme with said compound.

67. Method for preparing the composition according to any of claims 1 to 52, said method comprising the steps of providing at least one pigment and at least one enzyme capable of acting on a compound, wherein said action results in the formation of an antifouling species comprising an antifouling activity, wherein said compound does not form part of said composition, further providing a carrier for said at least one enzyme, and forming said composition by contacting said at least one enzyme with said carrier.

68. Use of at least one enzyme comprising an oxidase activity in the manufacture of a coating composition, wherein said coating composition does not comprise any substrate for said oxidase activity.

69. Use of at least one enzyme comprising an oxidase activity in a cleaning in place system, wherein said system does not comprise any substrate for said oxidase.
